(19) United States
(12) Patent Application Publication
(10) Pub. No.: US 2022/0088685 A1
(43) Pub. Date: Mar. 24, 2022

(54) REAL TIME QUALITY ASSURANCE FOR ADDITIVE MANUFACTURING

(71) Applicant: Divergent Technologies, Inc., Los Angeles, CA (US)

(72) Inventors: Michael KENWORTHY, Los Angeles, CA (US); Eric YANG, Los Angeles, CA (US)

(21) Appl. No.: 17/478,596

(22) Filed: Sep. 17, 2021

Related U.S. Application Data
(60) Provisional application No. 63/080,621, filed on Sep. 18, 2020.

(51) Int. Cl. B22F 12/90; G01N 27/90; B23K 26/03; B23K 26/342; B33Y 30/00; B33Y 50/00; B22F 12/50

(52) U.S. Cl. CPC B22F 12/90; G01N 27/90; B23K 26/0342; B22F 12/50; B33Y 30/00; B33Y 50/00; B23K 26/342

(57) ABSTRACT

In various aspects, 3D printers and recoaters incorporate sensor systems coupled to or integrated with the 3D printers. The sensor systems may include eddy current sensors and other sensors configured to measure an electromagnetic characteristic of the build piece. A three-dimensional (3-D) printer in one aspect includes a depositor configured to deposit metal, an energy beam source configured to selectively melt the metal to form a portion of a build piece, and a sensor configured to move relative to a surface of the print area and to measure an electromagnetic characteristic of the portion of the print area. The measured data can be used to detect defects and other information about the build piece that can be used to fix the defects or enhance the build piece geometry during the printing.

### CROSS-REFERENCE TO RELATED APPLICATIONS

This application claims the benefit of and right of priority to U.S. Provisional Patent Application No. 63/080,621, entitled “Realtime Quality Assurance Suited For High-Throughput Additive Manufacturing via Re-coater Mounted Sensing Systems”, filed Sep. 18, 2020, the contents of which are hereby incorporated by reference as if expressly set forth herein.

### BACKGROUND

### Field

The present disclosure relates generally to additive manufacturing systems, and more particularly, to real-time quality assurance of additively manufactured (or three-dimensional (3D) printed) parts.

### Background

AM systems, also described as three-dimensional (3D) printers, can produce structures (referred to as build pieces) with geometrically complex shapes, including some shapes that are difficult or impossible to create by relying on conventional manufacturing processes, such as machining. AM parts can advantageously be printed with diverse geometries and compositions using materials that allow the part to have specifically-tailored properties for a target application.

Various post-processing techniques may be used in AM systems after completion of the build piece to add or enhance features for the build piece. For example, certain measures have been proposed to address defects and geometrical anomalies in the build piece created during the print. Limitations nevertheless exist in these conventional techniques. One exemplary limitation is that manufacturers may face problems when they fail to address, or even notice, defects in the part that may occur during printing. These defects can worsen over time or can cause the printed part to be misshapen or defective. Even if such defects are somehow identified, they are often not adequately corrected relying on conventional post-processing fixes. For example, the defect may be buried deep in the finished part, and thus inaccessible. Conventional approaches may further worsen manufacturing latencies, increasing overall processing time for the part.

### SUMMARY

The following presents a simplified summary of one or more aspects of real-time quality assurance of additively-manufactured parts in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In conventional implementations, completed 3-D printed parts may be removed and examined in detail for cracks and other defects. Upon identifying such cracks or other anomalies produced during the build, manufacturers may use various post-processing operations, e.g., involving adhesives, fasteners, etc., to attempt to rectify the problems. In addition to the time-consuming nature that these tasks may impose on the overall print jobs, it may be difficult to detect fine cracks and other small voids or features that may later result in part failure.

Aspects of the present disclosure are directed to superior in situ techniques for identifying these problems and potential defects, and for reducing overall post-processing times to result in a superior part 3-D printed in a reasonable amount of time. Further aspects of the disclosure may include using these techniques to create a database of information that can be referenced in the future to model and print an ideal part.

In one aspect of the disclosure, a three-dimensional (3-D) printer includes a depositor configured to deposit metal, an energy beam source configured to selectively melt the metal to form a portion of a build piece, and a sensor configured to move relative to a surface of the build piece and to measure an electromagnetic characteristic of the portion of the build piece.

In still another aspect of the disclosure, a recoater system for a 3-D printer, can include a container for storing print powder, a leveler, a powder flow outlet, wherein the leveler is configured to smoothen the print powder from the powder flow outlet to form printable layers in a print bed for 3-D printing a build piece, and a sensor configured to move relative to the print bed to measure an electromagnetic characteristic of a portion of the build piece.

One or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Various aspects of multi-sensing technologies for detecting print artifacts in 3D printing and for addressing said defects in situ (in place) during the 3D printing process will now be presented in the detailed description by way of example, and not by way of limitation, in the accompanying drawings, wherein:

FIG. 1 is a side cross-sectional view of a sensor system coupled to a 3D printer.

FIG. 2 is a side cross-sectional view of another dual-sensor system coupled to a 3D printer.

FIG. 3 is a perspective posterior view of a recoater with an integrated eddy-current sensor.

FIG. 4A is a rear perspective view of a recoater with an integrated eddy current sensor.

FIG. 4B is a perspective view of an exemplary leveler or wiper that connects to the recoater of FIG. 4A.

FIG. 5 is a top view of an example recoater for use in various configurations.

FIG. 6 is a flow diagram of an exemplary action of an eddy-current sensor.

FIGS. 7A-C illustrate an example mitigation of an unintended protrusion from a build piece in a powder bed of a PBF-type 3D printer.

FIG. 8 is a top view of a 3D printer powder bed and recoater illustrating the use of eddy currents to help remove defects.

FIG. 9 is another flow diagram of methods for using a sensor system to identify and repair defects in a 3D printer.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The terms “exemplary” and “example” used in this disclosure mean “serving as an example, instance, or illustration,” and should not be construed as excluding other possible configurations or as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

The combined sensor apparatuses and methods for eddy current-based sensing and other means of real time data sensing, which may include identifying and potentially repairing potential defects, in this disclosure will be described in the following detailed description and illustrated in the accompanying drawings by various elements such as blocks, components, circuits, processes, algorithms, etc. These elements may be implemented using electronic and mechanical hardware, computer software, or any combination thereof.

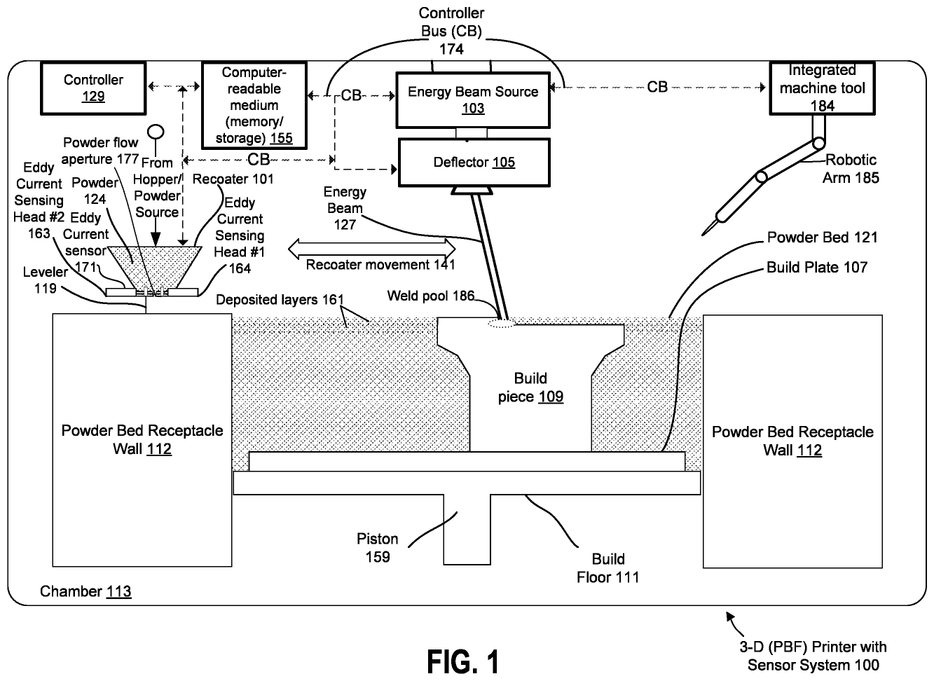

By way of example, an element, or any portion of an element, or any combination of elements may be implemented using one or more processors or controllers. Examples of controllers, such as that shown in element 129 of FIG. 1, for example, include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The one or more controllers may be part of a workstation or a server computer configured to perform the routines described herein. The one or more controllers may be included within a separate combined sensor system (including, e.g., imaging sensors, optical sensors, infrared sensors, eddy-current sensors, acoustic sensors capacitive sensors, pressure sensors, and the like, or any combination thereof) mountable on, or integrated with, a 3D printer. The one or more controllers may be operatively or electronically coupled to digital and analog circuits, memories, and any other circuits used of operating the one or more controllers, including data busses for connecting the components.

The one or more processors and/or controllers may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, object code source code, or otherwise.

Accordingly, in one or more example embodiments herein for providing sensor systems and 3D printers having the sensor systems, for 3D printing parts (build pieces), imaging print artifacts, receiving data to use in performing responsive actions such as automated in situ repairs, manipulating eddy currents for adjusting magnetic fields, removing inclusions, filling voids, melting unsintered or partially sintered print material, and performing other functions described herein, the functions may be implemented in hardware, software, or any combination thereof. If implemented in software, the functions may be stored on or encoded as one or more instructions or code on a computer-readable medium. Computer-readable media, as described below with reference to FIG. 1, includes computer storage media 155. Storage media 155 may be any available media that can be accessed by a computer or by the. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer. For purposes of this disclosure, the computer that may include the one or more processors may be directly or indirectly connected to a 3D printer, such as a powder bed fusion-based printer.

This principles of this disclosure may be applicable to a variety of 3D printer types, including but not limited to powder bed fusion (PBF) printers including selective laser sintering (SLS), direct metal laser sintering (DMLS), selective laser melting (SLM), electron beam melting (EBM), etc.

The present disclosure describes the use of sensor systems, including but not limited to eddy current sensor systems, that can enhance the quality and accuracy of parts generated during 3D printing, and using this sensor data to enhance the accuracy of assembly of 3D-printed parts by performing fixes not only after, but also during, the print. In various embodiments, sensor systems may detect information that may be used to determine defects or potential defects in a part while the part is being printed. For example, the sensor systems can in some embodiments include a combination of types of sensors that provide real-time data about the presence of undesirable inclusions, voids, and other defects in the part being printed. A common problem in certain 3D printers is spatter, or matter ejected during the heating of print material when forming a weld pool. Matter can be ejected, for example, from the area of the weld pool itself as the print material is heated quickly by an energy beam. If the ejected matter lands on a portion of the print area such as the build piece or powder that will be fused to form a portion of the build piece, an inclusion or contamination in the build piece may result. Other problems can include unintended voids to due un-melted print material, unsintered power, cracks in the portion of the part or build piece being constructed, and others. The 3D printer may use this data together with existing print specifications for the part (e.g., the CAD model, manufacturer's specifications, etc.) to evaluate whether identified defects or other artifacts require fixing or removal, including when any such actions should be initiated, if at all.

In various embodiments, sensor systems may detect information about the print material. For example, some sensor systems may detect contamination (such as spatter that landed in the powder), the powder density, quality of powder spread, variations in thickness of powder layer, etc. in powder-based 3D printing. Detecting powder density may include, for example, detecting hollow powder particles by using a sensor frequency matched to the powder size range. In various embodiments, powder layer thickness over the part may be measured, e.g., in embodiments with dual sensors mounted on a bi-directional recoater (in which powder layer thickness may be measured during the recoating itself) or in embodiments with a single sensor mounted on a recoater (in which powder layer thickness may be measured when the recoater returns to a starting position after the recoating).

In various embodiments, sensor systems may detect information about the geometry of the part being printed, for example, variations in geometry from the nominal geometry reflected in, e.g., the CAD model of the part. For example, various sensors may detect the edge of the part during printing. The edge of the part corresponds with the part's geometry (i.e., the part's dimensions). In some methods of 3D printing, producing dimensionally-accurate parts can be difficult. For example, in PBF an energy beam fuses powder material through melting selected areas of the top layer of powder material. However, the energy beam can also melt powder material and previously-fused powder material in previous layers, i.e., below the top layer. In various embodiments, sensor systems may detect information below the surface (e.g., below the top layer). For example, some sensor systems, such as those using eddy current sensors as described in more detail below, may detect the edge of a printed part from the top surface all the way down for multiple layers. In this way, for example, these sensor systems can detect and account for variations in geometry in previous layers caused by energy beam penetration below the top layer. This sensor information can provide a more accurate representation of the geometry of the part as it is being printed versus being able to detect the edge of the top layer alone. The information from multiple sensor scans can be combined to obtain a complete dimensional representation of finished part as soon as the printing is completed, thus eliminating the need to dimensionally scan the part during a post-processing step. In various embodiments, this dimensional representation may be used during automated assembly of the part with other parts to enhance the overall dimensional accuracy of the assembly.

An eddy current sensor may be implemented on a depositor or recoater, or any other part of the 3D printer that can enable the eddy current sensor to sense regions. The eddy current sensors can measure electromagnetic characteristics such as impedance, inductance, or current and field values. The eddy current sensors can use this information to identify fine unintended voids, un-fused or partially-fused print material, unsintered powder, cracks, inclusions, contaminants, etc. or other defects in the build piece under construction, identify powder characteristics (in powder-based 3D printing), and/or identify part geometries during printing. In some cases, implementing corrective measures during the print may be most useful while such errors are most accessible. In the case of detected defects in the build piece, for example, the system (such as a controller of the 3D printer) may modify the operation of the 3D printer to, e.g., mitigate the defect (e.g., physically remove the defect, such as by drilling or scraping out an inclusion, adjust printer parameters to correct the defect, such as increasing laser power locally applied to an area in which a void was detected in the current layer or a previous layer, e.g., to re-fuse the area of the defect), flag the defect (e.g., to inform a post-processing treatment such as hot isostatic pressing (HIP), drilling out the defect and filling in the hole afterwards, etc.), or the system may modify the operation by simply ending the print job (thus saving time and energy), or take other corrective measures.

In the case of detected errors in powder characteristics, for example, the system may modify the operation by removing a contaminant in the powder, removing at least some of the metal powder, pausing the print job and replacing the current batch of powder in the system with a new batch, depositing additional powder (e.g., perform an additional recoat), adjusting printer parameters to mitigate variations in measured powder layer thickness, ending the print job, etc. For example, if the powder layer thickness over the part is too thin in an area, the system may adjust the printer parameter of laser power to decrease the energy delivered by the energy beam in the thinner area.

In the case of detected variations in part geometry, for example, the system may modify the operation by adjusting printer parameters to correct or mitigate the dimensional error, may end the print job, etc. For example, in the case of incomplete fusing near an edge of a previous layer, the system may apply more laser energy near the edge of a top layer that is above the incompletely fused previous edge to melt or remelt the previous edge to extend (i.e., grow) the geometry of the part to compensate for the incomplete fusing in the previous layer. Similarly, in the case of an edge in a previous layer that protrudes beyond the nominal dimensions, the system may lower the laser power applied at the edge of the top layer based on the information that the power applied to the edge in the previous layer was too high and caused the edge to extend beyond nominal dimensions. In this way, for example, the system may modify the operation by adjusting printer parameters for future layers based on information that the parameters used for previous layers caused a variation in geometry, so that the future layers can be printed more accurately.

Accordingly, in various embodiments, the data from the eddy current sensor system enables the 3D printer and its related hardware components to repair defects during printing, mitigate when powder quality, thickness, etc. does not meet specifications, and/or adjust operation to account for errors in part geometry as the part is being printed.

In various embodiments, the 3D printer may identify a defect in or near real time using the integrated eddy current sensors. The controller may instruct the 3D printer to suspend the print. The 3D printer may repair the (then easily-accessible) defect, or extract the foreign matter, using a CNC machine tool, automated robotic arm, or other mechanism such as a brush or blade. In some arrangements, the controller may instruct the recoater to make selective deposits of additional print material, after which the controller may activate the 3D printer's laser or electron beam source to selectively re-melt and solidify the deposited powder. The energy beam source may also be used to melt an identified pocket of unsintered powder that is already present in the powder bed.

Different eddy current sensors have different capabilities. For example, as mentioned above some such sensors may be capable of providing the controller with information several layers down underneath the surface of the print bed or build piece. Upon detecting defects, cracks, or inclusions, or to re-solidify voided areas, the controller may re-melt one or more of the upper layers until the desired region is solid again, and/or the defect is removed.

Eddy current and similar sensors have advantages beyond merely effecting real time or near real time repairs of cracks and other anomalies. For a given part or part model series, for example, that is regularly printed, the eddy current sensor may gather data about the print. Relevant details may include an ideal set of impedances, geometrical data of the of the printed parts, an ideal geometry within a tolerance with respect to the nominal computer-aided design (CAD) file or digital model, or other factors that can be ascertained in real time using this sensing technique. Since the eddy current sensor can typically identify characteristics of the build piece below the surface, measurements using the eddy current sensor may be periodically taken and the data recorded. Over several parts, a database of build piece structural and geometrical characteristics may be gathered. During subsequent prints, the eddy current sensor can take further measurements and the measured data can be compared to the data in the database to ensure that the build piece falls within the necessary tolerances and has the characteristics of the nominal (ideal) part. Changes can be made if necessary during (or after) the AM process to bring parameters within their specified ranges, if necessary.

Immediately following the repairs or shortly thereafter, 3D printing can resume. In other arrangements, the controller may determine based on the detailed data that a fix is not needed and that the identified defect is innocuous and not harmful to the build piece. The controller(s) can therefore evaluate the diverse data about the defect to its benefit, determining in these cases that the print can proceed without further interruption.

Addressing fixes during the print may be quicker because the 3D printer has direct access to the problem. The system does not in that case have to unearth numerous layers before reaching the problem area, as may otherwise be required if every identified problem is just deferred until post-processing. Here, by contrast, post-processing times can beneficially be reduced, or reserved to other tasks. Another problem faced by manufacturers is whether the defect can even be detected or accessed at the post-processing stage in the first place. If the defect is buried in the middle of hardened metallic layers, for example, the defect may be difficult or impossible to detect, and even if it is detected might be infeasible to fix. The combined sensor system of the present disclosure can, however, provide additional, more diverse data to the controller that characterizes the nature of the defect. The 3D printer can better determine an appropriate time for the fix that increases quality assurance without causing undue inefficiencies.

In further embodiments, the 3D printer sensor system as disclosed herein also may include superior techniques to both identify and address defects. For example, an eddy current sensor system may optionally include a high resolution still or video camera so that visible images of the build piece may be time-stamped to correspond with the eddy current measurements. With these 3D views, the precise location of ejected material can be facilitated. Further, such defects can be neutralized quickly or immediately. In some embodiments, upon determining a landing location of ejected a particle of matter, the 3D printer may use an eddy current sensor to determine whether the particle creates or will create a defect in the build piece before they become deeply lodged underneath the layers.

FIG. 1 is a side cross-sectional view of an eddy-current sensor system coupled to a 3D printer. In an aspect of the present disclosure, the 3D printer system may be a powder-bed fusion (PBF) system 100. FIG. 1 shows PBF system 100 with its different components for performing different stages of operation. The particular embodiment illustrated in FIG. 1 is one of many suitable examples of a PBF system employing principles of this disclosure. It should also be noted that elements of FIG. 1 and the other figures in this disclosure are not necessarily drawn to scale, but may be drawn larger or smaller for the purpose of better illustration of concepts described herein. PBF system 100 can include a recoater 101 that can deposit each layer of metal powder (the print material in this example) in a print area (e.g., on top of a previous layer, which can include the top of the build piece, the top of the previous layer of metal powder, and/or the deposited layer of metal powder itself). (The print area in various types of 3D printers can be, for example, an area at which the metal powder is deposited and fused. For example, the print area in a DED system can include regions of the build piece that the nozzle points to deposit and fuse powder while printing). An energy beam source 103 that can generate an energy beam 127, a deflector 105 that can apply the energy beam directionally to fuse and thereby solidify the powder material, and a build plate 107 that can support one or more build pieces, such as a build piece 109. The terms “fuse” and/or “fusing” are used to describe the mechanical coupling of the powder particles and may include, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls of the powder bed receptacle 112 are shown in cross-section. In practice, the powder bed receptacle walls 112 may or may not form a closed perimeter, depending on the type and features of the 3D printer. The walls 112 generally define the boundaries of the powder bed receptacle, the latter of which is sandwiched between the walls 112 from the side and abuts a portion of the build floor 111 below. Build floor 111 can progressively lower build piece 107 so that recoater 101 is provided sufficient room to deposit a next layer. The entire mechanism may reside in a chamber 113 that can enclose the other components, thereby protecting the equipment, enabling atmospheric and temperature regulation and mitigating contamination risks.

A recoater system of PBF system 100 can include recoater 101 and a powder container that contains powder material, and recoater 101 can receive print material from the powder container. In some arrangements, the powder container may be integrated with or part of a leveler of recoater 101. In some arrangements, a powder container, such as a hopper (not shown) may be separate from a leveler, such as a leveler 119 in FIG. 1. The purpose of all of these embodiments, in general, is to provide print material to the powder bed 121. In the embodiment shown, recoater 101 is separate from the hopper, though they may both be considered part of the recoater system. In other embodiments, the hopper may be configured as a large drum or source of metal powder. Recoater 101 contains a metal powder 124, such as a metal or alloy-based powder, and leveler 119 that can smoothen or level the top of each layer of deposited powder 124 as it flows through a powder flow outlet, such as powder flow aperture 177, during a recoating cycle. The leveler 119 can be in the form of a blade, a roller, or similar device for smoothening and evenly distributing the metal powder. The hopper may act as a powder source that periodically fills the recoater 101 with powder (e.g., during a scan cycle) to enable the recoater 101 to deposit powder layers across the total necessary span of the powder bed 121.

During the recoating cycle, the energy beam 103 may be off (or idle) while the recoater 101 moves horizontally along the direction of arrow 141. In so doing, recoater 101 may deposit a layer 161 of material. The thickness of layers 161 is exaggerated in the figure for clarity. That is, recoater 101 is positioned to deposit powder 124 in a space created over the top surfaces of build piece 109 and powder bed 121 and bounded by powder bed receptacle walls 112. In this example, recoater 101 progressively moves over the defined space while releasing powder 124 via a powder flow outlet, such as powder flow aperture 177. As noted above, leveler 119 can smoothen or evenly level the released powder to form a powder layer 161 that leaves a surface of the powder bed 121 configured to selectively receive a fusing energy beam 127 from energy beam source 103 in a subsequent scanning cycle.

In some cases, the recoater 101 is configured bi-directionally, meaning that recoater 101 may deposit a layer 161 of powder in both directions. That is, in addition to depositing material as it moves from left to right along the axis of arrow 141, recoater 101 may also deposit a layer of powder through powder flow aperture 177 when it travels from right to left along the same axis. In this bi-directional embodiment of recoater 101, an additional leveler (not shown) similar to leveler 119 may be arranged opposite leveler 119 and may be configured to level powder deposited when the recoater 101 is moving from right to left. Thus, for example, a first recoater cycle may occur where recoater 101 deposits a first layer 161 moving left to right, followed by a scanning cycle. Then the recoater 101 can perform another scan as it moves from right to left to deposit another layer 161 of powder. Another scanning step can occur, and so on until build piece 109 is completed. In other embodiments, a single leveler 119 is used in the bi-directional recoater configuration, in some arrangements with multiple powder flow apertures on either side of the leveler 119 for dispensing print material depending on the direction of the recoater 101.

In this way, one scan cycle may follow every recoater cycle. During the scan cycle, the energy beam source 103 may use deflector 105 to produce an energy beam 127 (e.g., a laser beam) for selectively fusing a cross-sectional region of the uppermost layer that will become a portion of build piece 109. The regions of the top layer that will not be part of the finished build piece may be left unfused. The scanning of the energy beam to fuse material can be based on various printer parameters, such as beam power, scan rate (i.e., speed), powder layer thickness, etc. As described briefly above and in more detail below, in various embodiments, one or more printer parameters may be adjusted during printing based on sensor information to, for example, correct defects or dimensional errors in the build piece.

FIG. 1 may illustrate a time at which PBF system 100 has already deposited and fused slices (i.e., cross-sections of the build piece 109) in multiple layers (e.g., two hundred (200) individual layers) to form the current state of build piece 109, e.g., formed of 200 individual slices. The multiple individual layers 161 already deposited have created a powder bed 121, which includes powder that was deposited but not fused and a build piece 109 that has been fused. While energy beam source 103 scans the top layer of the build piece, the energy beam 127 may be powerful enough to re-melt material in one or more previous layers of the build piece underneath, e.g., in response to the eddy current sensor detecting a defecting in a prior layer that is still within range of the energy beam source 103. The 3D printer 100 is generally configured to account for this phenomenon where it occurs, to yield a build piece with the intended features (e.g., density, depth, etc.) by correctly modulating the energy of the laser or other energy source.

During this scanning cycle, energy beam source 103 forms a weld pool 186, which includes a region of powder 124 that is fused by the energy beam 127, and that temporarily melts as a result. The melted region in the weld pool 186 soon thereafter can solidify as intended to form a permanent part of build piece 109. Eddy current sensor 171 may be configured to make periodic measurements. In some arrangements, eddy current sensor 171 can map a geometry of the build piece by first determining an edge of the build piece 109, e.g., where the powder solidifies, including the edge of the build piece below the surface of the top of the build piece and/or powder layer, which may have been remelted and changed dimensions since the previous layers were fused. The eddy current sensor 171 can output impedance data to the controller 129, for example, to provide this characteristic data, in some arrangements on a streaming basis.

Each time energy beam source 103 completes the scan of a layer, build floor 111 can lower by a thickness of one of the powder layers 161. The lowering of build floor 111 causes build piece 109 and powder bed 121 to drop by that powder layer thickness, so that the top of build piece 109 and powder bed 121 are lower than the top of powder bed receptacle wall 112 by an amount equal to the thickness of one of the powder layers 161. In this way, for example, a space with a consistent thickness equal to this powder layer thickness can be created over the tops of build piece 109 and powder bed 121.

In various embodiments, the deflector 105 can include one or more gimbals and actuators that can rotate and/or translate the energy beam source to position the energy beam. In various embodiments, energy beam source 303 and/or deflector 305 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP). In embodiments incorporating electron beams as the energy source, deflector 105 can include deflection plates that can generate an electric field or a magnetic field that selectively deflects the electron beam to cause the electron beam to scan across areas designated to be fused. Deflector 105 can include an optical system that uses reflection and/or refraction to manipulate a laser beam to scan selected areas to be fused. Deflector 105 may be a lens, mirror, or another device that the controller can steer using its magnetic fields, for example, to direct the flow of an electron beam source. Because the electrons are charged particles, the controller can control their flow via the electric and magnetic fields. Where a laser is involved, which includes uncharged photons, a lens or mirror of the defector 105 can be directed in some embodiments to use reflection, refraction and other techniques to properly focus the laser on the correct area of the surface of the powder bed 121.

As noted, shown in FIG. 1 is a controller 129. Controller 129 may be connected to a memory (computer-readable medium) 155 via a controller bus 174. Controller 129 may in fact be a plurality of controllers. Controller 129 may perform the functions of a print controller. As shown by the dashed line representing the controller bus 174, controller 129 may also be coupled to recoater 101, to energy beam source 103, and to deflector 105. The circuitry that comprises controller 129 may be distributed in different locations of the 3D printer (e.g., different cores or different types of dedicated hardware or firmware), performing local functions in that manner. For example, controller 129 may include more than one general or special purpose processors distributed (e.g., in the form of logic circuitry, digital signal processors, field programmable gate arrays, application specific integrated circuits, and other digital technologies) across relevant portions of the 3D printer 100. In other embodiments, controller 129 may be part of a separate computer coupled to, and PBF printer system 100.

In some embodiments, controller 129 may retrieve in the memory 155 a computer-aided design (CAD) model representing the nominal dimensions of build piece 109. Controller 129 may compile the CAD model into a number of executable instructions corresponding to slices that the controller can use to print the build piece 109 using the scanning and recoating techniques and printer parameters described above. In some embodiments, the CAD model is already compiled by another source, and the compiled instructions are provided to controller 129 via memory 155. Controller 129 can use the print instructions to direct the behavior of the recoater, the energy beam source, and the deflector to properly produce build piece 109.

In various embodiments, 3D printing system 100 may further include an eddy current sensor 171 or a similar sensor that senses electromagnetic characteristics, such as impedances and field strengths, etc. While the eddy current sensor 171 can be coupled to different structures in various embodiments, in the embodiment of FIG. 1, the eddy current sensor 171 is coupled to recoater 101. A first sensing eddy current sensing head #1 (164) may be integrated in the housing of a first side of recoater 101. A second eddy current sensing head #2 (163) may be integrated in the housing of a second side of recoater 101. These orientations enable the eddy current sensing heads 1 and 2 (164 and 163) to be positioned directly over the powder bed when the recoating step is performed.

In operation, an eddy current sensor 171 may induce a changing magnetic field, which can penetrate the layers 161 of the powder bed 121. This induced magnetic field can create eddy currents within the conducting metallic powder in powder bed 121, and in the fused metal material in the build piece 109. The measured properties associated with the eddy currents (such as the magnitude and direction of the opposing magnetic field created by the currents) can be used to determine features of the build piece not only on the surface of, but also within, the build piece, such as four or more layers below the surface. The eddy current sensor may in some embodiments report back periodic impedance values, which can help detect whether cracks, voids, or unfilled powder, for example, is present in the build piece 109. In FIG. 1, the eddy current sensor 171 moves with the recoater 101. However, this need not be the case, provided that sensor 171 is in relative motion with the powder bed 121 or the build piece 109 therein.

During an ensuing recoating step, the eddy current sensor 171 can use the sensing heads 163 and 164 to measure features related to the ejected matter, including size, shape, geometry, density, and chemical composition. The eddy current sensor 171 can send its measurements to the controller 129. The controller 129 can use these measurements along with the data from the image sensor 148 to make real time determinations including (i) whether some type of on-site repair or removal is necessary; (ii) if a fix is necessary, whether the fix should be implemented immediately, at a specific time, or after the print in post-processing, and (iii) the nature and extent of the fix. As for (iii), for example, the fix may involve fusing a crack, adding and sintering material to fill voids, or removing ejected matter, among other possibilities.

In various embodiments, the eddy current sensor 171, together with the (optional) integrated machine tool 184 including robotic arm 185 and controller 129, can form a closed loop wherein the controller 129 can make on the fly assessments about the need for repairs (e.g., re-melts to fill voids). Controller 129 can further communicate with robotic arm 185 over controller bus 174. Controller 129 can, for example, submit commands for the 3D printer to suspend printing (if necessary), and to use robotic arm 185 to perform machining in the powder bed 121 or the build piece 109 to fix a defect, remove an inclusion, etc. In some configurations, the integrated machine tool 184 with the robotic arm 185 may be configured to perform conventional types of machining operations. For example, the robotic arm 185 may be configured to perform subtractive manufacturing to remove spatter that became fused to the build piece 109. The 3D printer may then apply “patches” to add and solidify material to the build piece where the spatter was removed, before the 3D printer 100 resumes full print mode. In the case of partially fused or unfused material in the build piece 109, the robotic arm 185 may be configured to remove just enough material to access the area of partially fused or unfused powder, after which the 3D printer may apply an energy beam from energy beam source 103 to the region to solidify the partially fused or unfused powder and remove the defect. In various embodiments, the 3D printer may simply apply the energy beam without first removing material.

While integrated machine tool 184 and its robotic arm 185 can be an effective way to perform in situ repairs, some 3D printers may lack this equipment. In that case, the repairs can be performed using different types of equipment or even external equipment, so that the machine tool 184 may be omitted in some embodiments.

In various embodiments, other types of non-optical sensors may be used in the 3D printer 100. Exemplary types of sensors may include acoustic sensors, capacitive sensors, seismic sensors, etc. These different sensors may be used together with (e.g., to complement), or in lieu of, eddy current sensor 171 to feed information to the controller 129 about defects that they uncover. The defects may include not only inclusions as noted, but other problems such as subsurface voids (empty regions below the surface of the powder bed 121), or a region of partially sintered or unsintered print material that should otherwise be solidified in the build piece. Capacitive sensors function by detecting changes in the electric field. In some embodiments, capacitive sensors may be placed relatively close to a surface of the powder bed such that a sufficient dielectric can be implemented to allow an alternating current source to measure an electric field of the dielectric during operation of the capacitive sensor. Likewise, in practical implementations, the acoustic sensor is placed sufficiently close to the powder bed 121 to render reliable acoustic measurements. Acoustic wave devices or sensors may be integrated in the respective ends of the re-coater, and may use piezoelectric material to apply acoustic waves to the powder bed region. Changes can be detected based on changes to the waves. Some acoustic sensors may rely on changes in audible noise to detect the presence of potential defects or foreign matter.

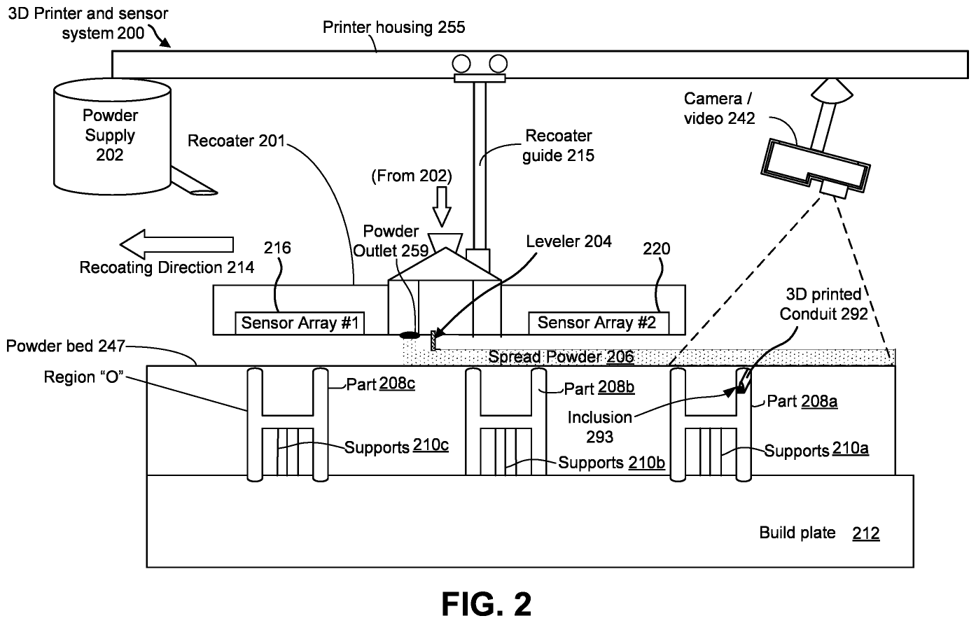

FIG. 2 is a side cross-sectional view of a 3D printer and sensor system 200. As before, a build plate 212 is used to support the print material and build piece(s). After the controller (such as controller 129 in FIG. 1) has compiled the print instructions, a recoater 201 can successively deposit print layers onto the build plate 212 to form powder bed 247. Recoater 201 may be mounted on a recoater guide 215. Between each deposition cycle, an energy beam source (not shown) can be used to effect a corresponding scan cycle in which select regions of the layer are solidified. Three build pieces 208a-c shown each include a set of support structures, respectively labeled as supports 210a, 210b, and 210c.

The supports 210a-c are not part of the build pieces 208a-c, and may be removed (e.g., via dissolution, controlled physical force, etc.) after the print is completed. Portions of the build pieces exceeding a certain angle (e.g., 45°) may require support structures so that the members do not deform due to thermal effects encountered during the 3-D printing process or otherwise lose their dimensional integrity under their own weight. In some printers, portions of a build piece that extend by an amount greater than 45° from a vertical position—such as the horizontally disposed “Region ‘O’” segment of build piece 208c—may require support structures 210a-c to maintain the integrity of the respective build pieces 208a-c. This helps prevent the build pieces from deforming due to lack of sufficient thermal conduction or other forces. In these cases, the supports 210a-c can be removed after printing.

Recoater 201 may receive print material from a powder container, such as a powder supply 202. Recoater 201 may include a powder flow outlet, such as powder outlet 259, for spreading powder during the recoating step. As recoater 201 proceeds towards recoating direction 214 over the powder bed 247, the recoater 201 leaves spread powder 206 in its wake. Recoater leveler 204 may level the powder as it is deposited to ensure that the new powder layer is evenly distributed across the powder bed. As in the 3D printer 100 of FIG. 1, the spread powder 206 and build pieces 208a-c are supported by a build plate 212.

3D printer and sensor system 200 further includes sensor arrays #1 and #2 (216 and 220), which in the present embodiment include eddy current sensors. In various embodiments, sensor arrays 216 and 220 may be, for example, acoustic sensor arrays, capacitive sensor arrays, optical sensor arrays, etc. 3D printer and sensor system 200 also includes a printer housing 255, only a portion of which is shown to avoid unduly obscuring the concepts of the disclosure. Printer housing 255 may, for example, be a portion of a print chamber or outer wall. The interior of printer housing 255 may include an optional image sensor 242, such as an optical sensor (e.g., a camera or video monitor), an infrared sensor, etc., which may be pivotally or movably affixed on a surface of the inner housing. Image sensor 242 may image a weld pool or a portion of a recoated layer, for example. Sensor arrays 216 and 220 may optionally use information provided by image sensor 242, including data identifying a trajectory or a landing location for ejected matter particles. As described above, sensor arrays 216 and 220 may identify more detailed information about the ejected particles and may provide the information to a controller or processor array to determine what kind of response is appropriate, if any.

Eddy current (EC) sensors, such as in sensor arrays 216 and 220, may optionally use information from an optional image sensor to examine identified landing areas of ejected matter. In some embodiments, EC sensor arrays 216 and 220 may be configured to detect finer defects on or within the build pieces 208a-c such as unintended voids, un-fused or partially-fused print material, unsintered powder, cracks, inclusions, contaminants, etc. In some embodiments, EC sensor arrays 216 and 220 may be configured to detect the edges of the build piece (including edges of the build piece below the top surface of the build piece and/or powder layer) and to map progress of the build geometry as it evolves during the additive manufacturing process. In this way, digital representations of the geometry of the actual build piece can be generated as the build piece is being printed, e.g., in real or near-real time. These digital representations of the build pieces 208a-c may be matched against the nominal (CAD) geometry, such as that identified in the original CAD models, to ascertain part accuracy data. The digital representations generated by the sensors may also be used in combination with other process knowledge (such as other known contributors to distortion) after removal of support structures 210a-c, heat treatment and machining, etc. Information from, for example, the EC sensors information can be combined or otherwise used with imaging data from the image sensor 242 to further increase quality assurance in additive manufacturing systems. For example, EC sensors can be capable of sensing phenomena below the surface of the build piece and powder layer, and in fact may be able to sense multiple layers below. Because the energy beam may melt not just the powder layer, but also may melt a portion of the previous powder layer(s) or re-melt a portion of one or more previously-fused layers below, the energy beam may cause irregularities in the geometry of the build piece that cannot be determined by sensing the top surface (e.g., with image sensor 242). In this way, for example, a sensor that can sense below the surface of the build piece and/or powder layer(s) may provide valuable additional information that may be used with the information from a sensor that senses the surface. The data may also be included in a database to facilitate faster prints of the same part or product line.

More generally, sensor arrays 216 and 220 may be positioned and held at a minimum gap relative to the surface of the deposited powder layer for a stable reference position of the sensor arrays. The sensor arrays 216 and 220 in the embodiment of FIG. 2 are incorporated into the recoater 201. Like in the implementation shown in FIG. 1, sensor array 216 is arranged on one side of the recoater leveler 204, and sensor array 220 is arranged on the other side of the recoater leveler 204. In this manner, each pass of the recoater 201 can results in two sets of measurements by the EC sensor arrays. These include measurements of the powder bed 247 after printing in a layer but prior to the deposition of the next layer (e.g., spread powder 206), and measurements of the powder bed 247 immediately following the deposition of the next powder layer. Thus, the embodiment of FIG. 2 results in two sets of data sensing the same state of the build (i.e., sensor array 216 senses before spread powder 206 is deposited and sensor array 220 senses after the spread powder is deposited), which may provide higher precision measurements involving potentially more subtle features. For example, these methods may result in detailed sensing of the powder bed 247 with and without a next layer of powder being deposited.

In some embodiments, sensor arrays, such as recoater-mounted sensor arrays, may include a variety of different types of sensors, e.g. in the dual recoater locations on opposite sides of the leveler and deposition mechanism (e.g., arrays 216 and 220). For example, with reference to sensor arrays 216 and 220 of FIG. 2, one of the arrays may be an image sensor and the other of the arrays may be an eddy current sensor. As another example, in various embodiments a portion of sensor array 216 may be an optical sensor and another portion of the same sensor array 216 may be a non-optical sensor. Further still, sensor 218 can likewise be partitioned in this manner to incorporate both an optical and non-optical sensor. In some embodiments the recoater 201 may be built with bigger sensing heads to accommodate the necessary electrical circuits and mechanical components to implement this level of sophistication. In various embodiments, a sensor array may be mounted on only one side of the leveler of a recoater with the other side of the recoater having no sensor. In various embodiments, the one or more sensors and/or arrays may be arranged elsewhere in the build chamber (e.g., not on the recoater) or in addition to sensors mounted on the recoater.

In various additional embodiments, imaging sensors can be positioned on the recoater 201 as described above, but a separate camera or high resolution video monitor 242 can remain as an additional source of image sensing, which can advantageously be used during the scanning cycle, e.g., to scan for ejected matter, to image the build piece when impedance measurements are taken, and to determine an initial landing location of spatter.

For defect detection, the eddy current sensor or other electrical-based sensor can use electrical or magnetic fields (or in some cases applied current) to determine a target impedance in the area of the powder bed 247 or the build piece 208a-c being sensed. The measurement of target impedance may beneficially enable the sensor arrays 216, 220 or processor(s) (e.g., controller(s) 129) receiving the sensor data to determine and account for potentially unexpected discontinuities in the material, which may increase its measured impedance. Thus, by measuring localized impedance to a high enough spatial resolution, the sensor may flag those impedance values outside of an acceptable range as potential discontinuities in a build piece being printed. These discontinuities may then be fixed, especially if crack initiation has begun to occur. Even with insufficient spatial resolution of impedance measurements, computer simulations may be used in combination with the impedance data to determine interpolated impedance measurements and flag deviations from this expected value. Thus computer measurements can further increase the precision of the sensors in identifying unwanted artifacts.

The sensing head(s), e.g., sensor arrays 216 and 220, including eddy-current sensing and/or other sensors, may also be used to detect subsurface voids formed in the material. The rapid melting process in metal additive manufacturing can result in voids that form in the lower layers of the part being printed while the outermost surface may appear perfectly smooth. This detection may advantageously anticipate cracks that may form after subsequent thermal cycling/re-melting in the additive manufacturing process. These types of defects may come to light based on irregular impedance readings, and can be promptly fixed in situ as the print job is temporarily suspended.

Optionally, for example, camera (still or video) 242 can monitor the progress of the scan and can flag any unusual anomalies, such as spatter material landing in an area of powder to be fused or in an area of the build piece already fused. Eddy current (EC) sensors (e.g., sensor arrays 216 and/or 220) can use this data to identify whether voids may be present in the lower layers. As an example, the controller(s) 129 (FIG. 1) or the eddy current sensor arrays 216, 220 may not detect any surface discrepancies at a location even though recent image data from image sensor 242 may indicate a potential anomaly at the location, because the surface may appear smooth. However, the controller(s) 129 or EC sensor arrays 216, 220 may rely on older image data from earlier layers, combined with additional measurements by the EC sensor arrays 216, 220 within the layers, to collectively determine that cracks or voids may be present a few layers down within one of the build pieces 208a-c. In this way, for example, non-image sensors may benefit from earlier image readings of prior layers in some cases to assist in determining whether defects are present, and 3D printing may be suspended until these defects are corrected.

Some 3D printer designs utilize a single recoating (powder deposition) direction and other more efficient designs utilize bi-directional recoating. In the case of single-direction recoating, the recoater 201 may commonly be equipped with two sets of sensing heads (a first set and a second set) on either side of the recoater 201. In this single-direction case, one set of sensing heads (e.g., array 216) is always on the leading edge of recoater 201 as the recoater travels to deposit and spread powder 206. The other set of sensing heads (e.g., array 220) is always on the trailing edge of the recoater, because the recoater in this embodiment may deposit powder while traveling in one direction only. In the single direction recoating case, similar to the bi-directional recoating case, the sensors on the re-coater may obtain measurements both before and after powder deposition, because one sensor can take measurements before powder deposition and the other sensor can take measurements after. These impedance values or other electromagnetic characteristics may then be stored in a memory or database.

Conversely, in the case of bi-directional recoating in which the recoater 201 is equipped with two sets (a first array 216 and a second array 220) of EC sensing heads on either side of the recoater 201, the first set (array 216) is on the leading edge and the second set (array 220) is on the trailing edge when the recoater travels in one direction to deposit powder, and the first set (array 216) is on the trailing edge and the second set (array 220) is on the leading edge when the recoater 201 travels in the other direction to deposit powder.

One advantage of incorporating the sensing head(s) into the recoater 201 as described in FIGS. 1 and 2 is that the eddy current sensing speed (versus other technologies) can be high enough to be tuned to occur concurrently with the required recoating step. This configuration can support high throughput printer requirements. For example, in layer-based imaging methods, most often a static picture from a camera requires an extra second or two on each layer, potentially accumulating to add many minutes to a large build job. These embodiments in FIGS. 1 and 2, wherein the eddy current sensors can be included on the recoater 101, allow the sensors to work concurrently with an already occurring step (e.g., the recoating step), without adding time to the print job.

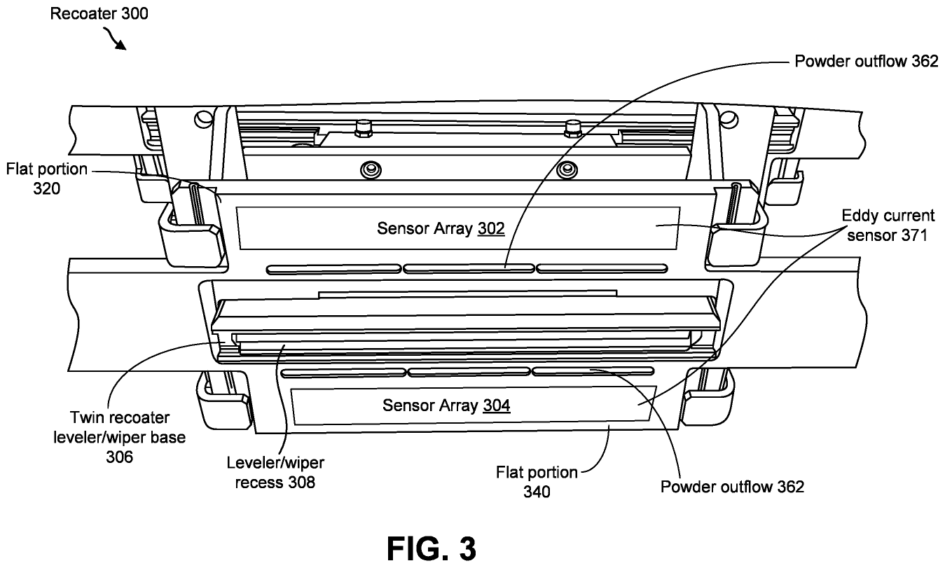

FIG. 3 is a perspective posterior view of a recoater 300 with an integrated eddy-current sensor 371. The perspective orientation of the recoater 300 is from a vantage point looking up and slightly angularly at the bottom of the recoater 300 from the surface of the powder bed. The recoater 300 may be a bidirectional recoater. A bidirectional recoater may be configured to deposit print material in both directions traversed by the recoater 300, such as from left to right, and thereafter from right to left. A bidirectional coater can be used to speed up the print job because scans can be performed after the deposition of each layer. The 3D printer does not have to wait for the recoater 100 to return to an originating side before applying the next re-coat.

Recoater 300 includes a powder flow outlet, labeled powder outflow 362 from which powder can flow in a controlled manner onto the powder bed as the recoater 300 progresses. In some embodiments, recoater 300 can be equipped with a twin recoater leveler element such as rubber wipers, which may be inserted on the twin recoater leveler/wiper base 306 using the leveler/wiper recess 308. One leveler may be operable to smoothen the deposited layer out as the recoater 300 moves across the powder bed in a first direction. Another leveler may perform the same function, smoothening the deposited layer out when the recoater 300 deposits the print mater in the other direction. In some embodiments, a single blade/leveler is used for both scan directions.

Eddy current sensor 371 may be integrated as sensor arrays 302 and 304, along with associated sensor circuitry, into respective flat portions 320 and 340 of the recoater 300. The illustrated configuration of FIG. 3 allows the eddy current sensor 371 to have additional area close to the powder bed to operate.

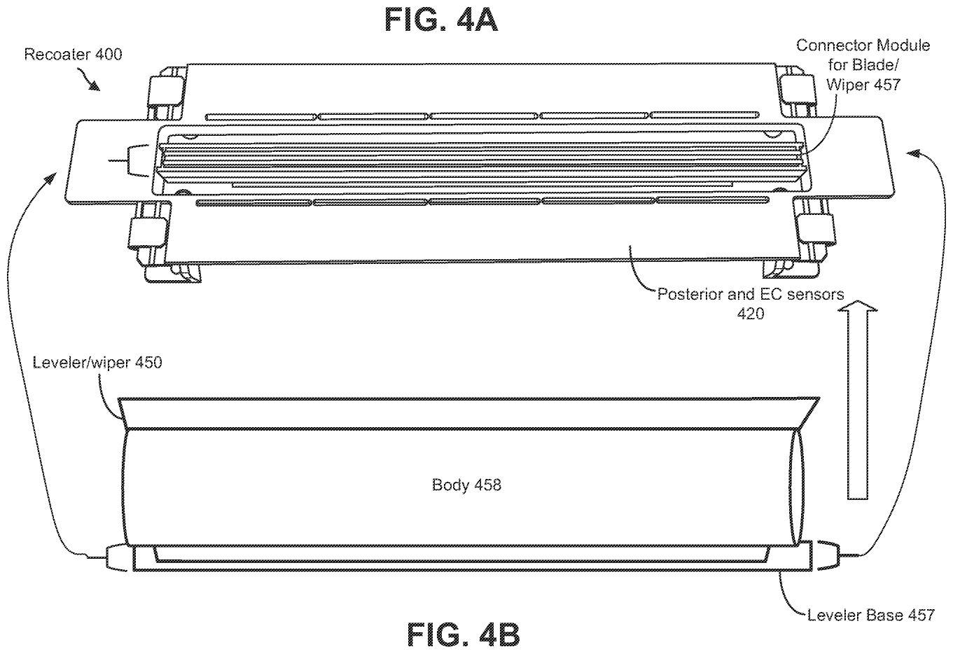

FIG. 4A is a rear perspective view of a recoater 400 including a base with an integrated eddy current sensor. The recoater 400 includes a posterior region 420, within which the eddy current sensor circuitry is built. At the center of the posterior region is a connector module 457. Connector module 457 can be used as a base for affixing a leveler, such as a blade or rubber wiper.

FIG. 4B is a perspective view of an exemplary leveler or wiper 450 that connects to the recoater of FIG. 4A. The body 458 of the leveler 450 is cylindrical in this example, although the physical configuration of the leveler 450 may also be flat, or another geometry. Leveler 450 can be equipped with a leveler base 457 which, as shown by the arrows, is pre-configured to snap into place when coupled to the connector module 457 of the recoater 400 in FIG. 4A. This beneficial arrangement enables the user of the machine to replace the leveler or wiper when it becomes dull or worn, without having to replace the entire recoater 400 and electronic sensors within. In other configurations, the leveler and recoater may be part of a single unit. In still other examples, the body 458 can be permanently affixed to the recoater 400, but with replaceable levelers 450.

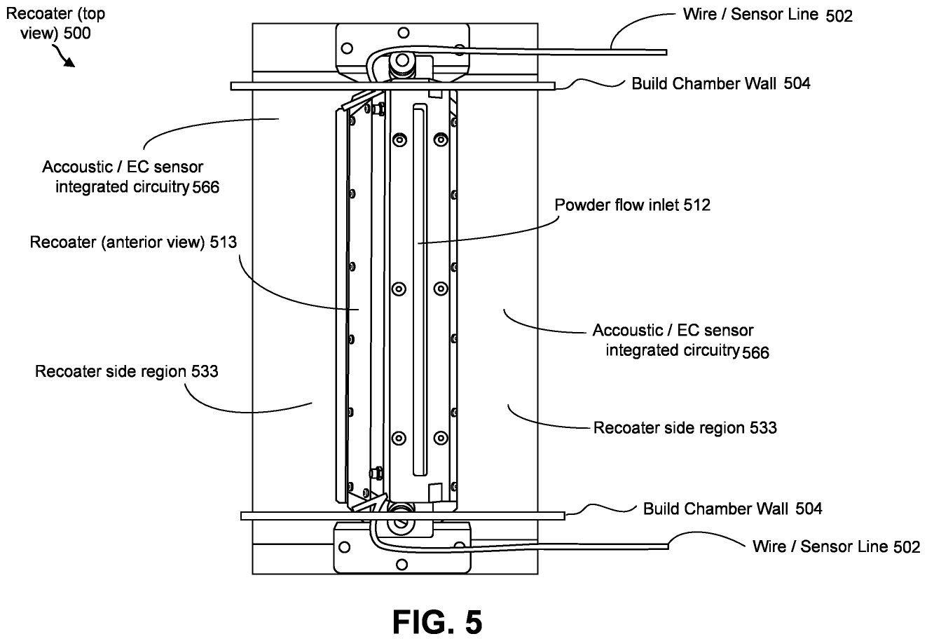

FIG. 5 is a top perspective view of a recoater 500 with an integrated non-optical sensor, such as acoustic/EC sensor integrated circuitry 566, in a recoater side region 533. The top surface of recoater 500 may include an anterior portion 513 that includes a region where fresh powder can temporarily be stored for use during recoats. Recoater 500 may further include a powder flow inlet 512 for receiving powder from a depositor, hopper, powder drum, or other print material source. The powder flows into the region defined in part by the walls in the anterior portion 513.

In the embodiments presented heretofore, with the acoustic and eddy current sensors integrated in the recoater 500, signals may be transmitted and received for producing and sensing acoustic signals and eddy currents (e.g., in one embodiment, by powering an electromagnet that sends magnetic fields into the relevant portions of the powder bed to generate eddy currents). Received signals can be tracked to determine the value of the fields or the currents at any given time, to thereby determine impedance values and other measurements that may characterize defects in the print job.

A wide variety of possible methods may be available to provide these signals, for example, to a controller (which may be located within or outside of a printer housing or build chamber) to process the signals. Each of these possible methods is intended to fall within the scope of the present disclosure. For example, various such techniques involve retrieving the eddy current sensing head signals out of the build chamber and to a control box, which may either be incorporated as a modular system external to the 3D printers or which may instead be fully embedded outside the build chamber but otherwise connected to the 3D printer. For example, in one such embodiment, a sensor line, e.g. for power, sensing signals, control signals, etc., can include small wires 502 routed along, or hidden within, the build chamber walls 504. This configuration can minimally impact the air flow uniformity in the print chamber required for acceptable process performance during the print. The wires 502 for the sensor can be routed through a small aperture in the build chamber walls 504 and thereafter into the eddy current sensor. On the other end, the sensor line can be routed to and from the modular system described above. The modular system in this embodiment is outside the build chamber walls and therefore can generate large currents or perform other functions for the eddy current sensor, without disrupting operation of other aspects of the printer.

In real time or over multiple builds, the data from the sensors can be used to improve build piece accuracy by comparing as-printed geometry to the nominal geometry. For example, this data may be used to determine if any calibration drift has occurred in the scanning system in the additive manufacturing system. Algorithms may be used to enable a better fit of the as-printed geometry to the nominal geometry. Furthermore, this data may eliminate or reduce other costly destructive and non-destructive inspections including mechanical witness specimen tests, coordinate measuring machines (CMMs) or structured light scans for dimensional verification, x-ray computed micro tomography (XCT) for material verification, etc., in non-design specific, flexible, fixture-less manufacturing systems that use additive manufacturing and advanced robotic assembly systems. A dimensional verification step of scanning the additively manufactured build piece and comparing it to the nominal CAD geometry may be performed prior to assembly by advanced robotic assembly systems due to the current state of print accuracy (˜1% typical), and a robotic path may be compensated accordingly using such scan information. In other words, a pre-inspection step comprising dimensional verification by scanning the additively manufactured part and comparing it to the nominal CAD geometry prior to assembly may be required to consider the overall part accuracy, resulting from both the printing accuracy and process accuracy (e.g. post-processing, support removal from 3D printed part, etc.). This pre-inspection step can help determine whether a target geometric accuracy will be achieved or not. These functions can be integrated within the sensors and processors of the 3D printer described herein.

The present disclosure may also yield other advantages for manufacturing techniques that may follow the 3D printing. For example, the 3D printed build piece may subsequently be assembled into a larger part. This larger part may be a vehicle, an aircraft, spacecraft, and another type of transport device. In some cases, the larger part may be a machine that may or may not have any mobility or transport functions. The various sensor data obtained during the 3D printing step can, in various embodiments, be used to streamline the assembly of the 3D printed part, such as when the subsequent assembly is performed at a robotic station. The robotic station may be a cell in the same facility, or it may be off-site. The impedance data or other electromagnetic characteristics (and images) gathered during 3D printing can be transferred to the robotic assembly station and used to ensure coherent assembly of the 3D printed part, often, but not necessarily, on a fully automated basis. Thus with or without recognized defects, the detailed geometric and compositional data gathered during the 3D printing of the build piece may be invaluable for use by the robotic station in the subsequent assembly.

In various embodiments, the eddy current sensing systems, for example, the geometric data traceable to the build piece in the printer (the part accuracy measured as the part is being printed) may be used to guide robotic path compensation to account for distortion/variation with respect to nominal characteristics of the CAD part model during a subsequent robotic assembly process involving the printed part. In these embodiments, the build piece accuracy as tracked by the 3D print sensor data can provide additional detail to a subsequent advanced robotic assembly involving the part.

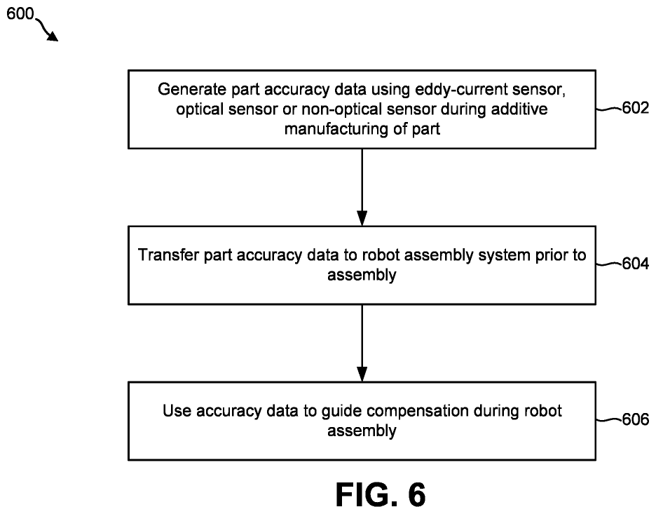

FIG. 6 is an exemplary flow chart of an example method of using sensor data from multiple sensors in a 3D printer and utilizing that data while assembling 3D printed parts in a robotic assembly system. At 602, during printing, build piece accuracy data can be generated using an eddy current sensor, for example. This information can be maintained in a memory (such as computer-readable medium 155 of FIG. 1) on the 3D printer. As an example of this step, the eddy current sensor in the 3D printer may provide edge detection data from each of the layers and/or multiple layers at a time. These edges can be combined to form a three-dimensional representation of the build piece geometry. In various embodiments, the eddy current data can in the 3D printer include a sensed depth of different locations in each powder layer, and the sensed depth data may be used to refine the representation of the part geometry. The build piece accuracy data may then be transferred to the robotic assembly system as described in FIG. 6 (step 604), to be used to make any necessary corrections when the 3D part is installed within the vehicle or other assembly.

At 604, the sensor data in the memory (e.g., memory 155) can, after the print, be transferred to a separate robot assembly system prior to assembly of the build piece, e.g., within a vehicle or other mechanized assembly. Thus, for example, the controller bus 174 of FIG. 1 can in some cases be networked to other stations in a manufacturing facility, including a robot assembly cell.

At 606, the data used to determine the accuracy of the 3D print job can also be used to guide installation during the robotic assembly into the larger mechanical structure. This may include using the 3D print data to compensate for prospective deviations from the 3D CAD print model, for example, and the build piece. In various embodiments, all of these techniques can be performed automatedly, without the requirement of manufacturer intervention.

As an example of 606 of FIG. 6, when guiding compensation during robotic assembly, the robotic assembly system may use adhesive to structurally bond the parts together by filling a groove in one additively manufactured part and inserting the tongue of another additively manufactured part into the adhesive-filled groove to bond the parts together. The tongue and groove can have a gap between them, the gap being filled with the adhesive. In some assembly systems, the adhesive-filled gap can be substantial enough to allow meaningful variation in the positioning of the two parts relative to each other when they are assembled. For example, there may be a 1 mm gap between the tongue and the groove on both sides of the tongue, and there may be a 3 mm gap from the end of the tongue to the bottom of the groove. In this case, for example, there may be up to 2 mm variation from side-to-side and 3 mm variation in insertion depth. The build piece accuracy data generated from the eddy current sensing may be used to guide compensation during robotic assembly. For example, the part accuracy data might show that a build piece is two (2) mm too long along the direction that the part will be joined with another part. In this case, the robotic assembly system might use the build piece accuracy data to guide compensation such that the robot inserts the build piece an additional 2 mm further in the joining direction to compensate for the 2 mm in additional length of the inaccurately-printed part, thus ensuring the length of the final assembly is correct.

Various embodiments may include tagged monitoring of the area of the weld pool with the eddy current sensing system, an acoustic sensor, etc. for a prescribed number of n build layers. The inclusion can be monitored for evidence of crack initiation. Builds may be stopped or flagged for later repair/inspection as warranted. It may be desirable to continue the print job until more than one, or a number, of defects are identified. That way the 3D printer can efficiently continue without interruption, as the builds are flagged for later repair or further inspection. In some embodiments, controller 129 (FIG. 1) can instruct the printer to print a physical marking on the outside of a build piece to indicate the location of the inclusion. The defects can later be addressed in post-processing stages. In some embodiments, the defects can be addressed by suspending printing before it is complete, such as at a time where the controller 129 may determine that the printer is at a stage where repairs should no longer be deferred.

In embodiments where the inclusion is later determined by sensors to be trapped internally in the part, a conduit can be 3D printed as a feature with the part to provide mechanical or fluid access to the inclusion. Referring back to FIG. 2, it is assumed for simplicity that inclusion 293 (enlarged for illustrative purposes) had been previously ejected from the weld pool.

This 3D printed conduit 292 can enable removal of the inclusion via a mechanical removal (e.g. machining tool or vacuum), or use of chemical agents. Referring briefly to FIG. 2, after the inclusion 293 can be removed, the conduit can be filled with the parent material, casting material, or any other suitable material to occupy the void left by the inclusion 293. Conduit 292 may be filled in by 3D printing (e.g., by another 3D printer) in a size that is commensurate with the inclusion 293. 3D printing may be suspended while the conduit 292 is inserted into the powder bed 247 and the inclusion 293 is removed.

In more complex cases where an inclusion is oriented such that it covers unsintered print material that is part of a printed part itself, a conduit can first be 3D printed and used to remove the inclusion 293. The conduit can then be filled with molten print material, or other material in liquid form that solidifies at room temperature and that has features consistent with that of the build piece from which the unmelted powder originated. Additional layers can be added, via the conduit or otherwise, and then melted to reinforce the part, or to substitute for that portion of the build piece that was occupied by the inclusion.

In various embodiments, the sensors may act in concert with the controller(s) and other systems to form a closed repair loop. As shown in FIG. 1, an automated machine tool 184 can use a robotic arm 185 to perform automated repairs based on data gathered from the sensors. In other embodiments, the 3D printer/sensor system 100 may include a vacuum, brush, scraper, or other type of tool in addition to or instead of the robotic arm 185 to remove the defective area and initiate an in-situ repair.

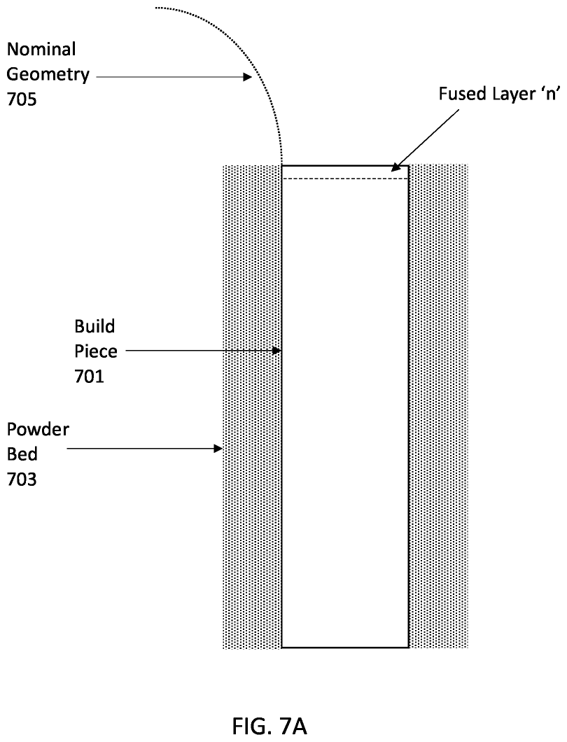

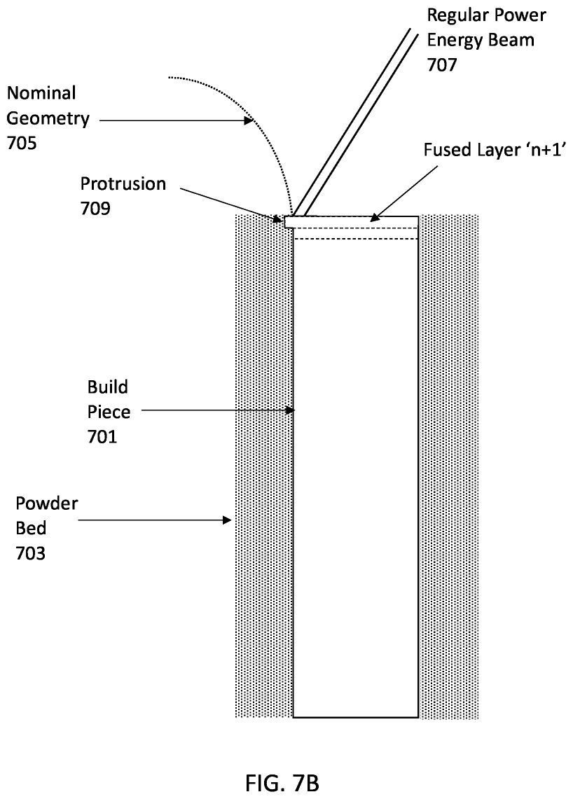

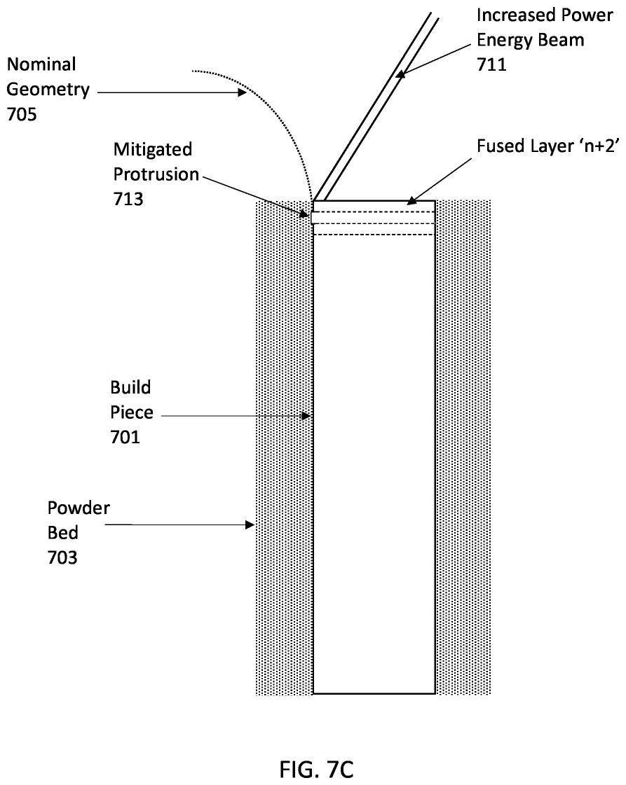

FIGS. 7A-D illustrate an example mitigation of an unintended protrusion from a build piece 701 in a powder bed 703 of a PBF-type 3D printer. Nominal geometry 705 of build piece 701 is the geometry to which the build piece is intended to conform. FIG. 7A shows build piece 701 immediately after a fused layer ‘n’ has been fused in a scan cycle of the 3D printer, in which an energy beam (not shown) scanned the print area to form fused layer ‘n’. Fused layer ‘n’ accurately corresponds to nominal geometry 705.

FIG. 7B shows the fusing of the next layer, i.e., fused layer ‘n+1’, during the next scan cycle, in which a regular power energy beam 707 is used during the normal operation of the 3D printer to scan the print area. However, in this layer, regular power energy beam 707 produces an unexpected result, protrusion 709, which may have been caused, for example, by the energy beam melting too much powder material in powder bed 703. In other words, the energy beam produced unexpected, extra fused material. Protrusion 709 is a variation of the geometry of build piece 701, i.e., the protrusion deviates from nominal geometry 705.

After the scan cycle shown in FIG. 7B, the 3D printer can operate a sensor, such as eddy current sensor 171, to move relative to the print area, e.g., the surface of fused layer ‘n+1’ and the surface of powder bed 703, to measure an electromagnetic characteristic of the print area. In this way, the variation of the geometry of build piece 701, i.e., protrusion 709, may be detected. The 3D printer, e.g., a controller of the 3D printer (not shown), may modify an operation of the 3D printer based on the measured electromagnetic characteristic. In this case, the controller may modify the next scanning cycle of the 3D printer by changing the scan path of the energy beam to stop short before reaching the planned stopping point to create the edge of the build piece in the next layer (‘n+2’). The new stopping point may be, for example, a location in the next layer that is above and slightly to the right (as viewed in the figure) of protrusion 709. The controller may further modify the operation by increasing the energy beam power at that location. In other words, the controller may control the energy beam to scan the other portions of the build piece in the next layer at regular power, but may increase the power when the energy beam is scanning at the new stopping point, i.e., the location above and slightly to the right of protrusion 709.

FIG. 7C shows the fusing of the next layer, i.e., fused layer ‘n+2’, during the next scan cycle at a time that the controller has modified the operation to stop the scan short and increase the power of the energy beam. At this time, an increased power energy beam 711 fuses powder material above and slightly to the right of protrusion 709. The increased energy beam power can cause a portion of build piece 701 slightly to the right of protrusion 709 to re-melt at a higher temperature than would have occurred if the energy beam were operating at regular power. The increased melting temperature at this point may result in a contraction in the fused material when that re-melted portion cools, thereby pulling protrusion 709 back in towards nominal geometry 705, resulting in a mitigated protrusion 713. At the same time, because the scan stopped short of the planned path out to the edge near nominal geometry 705, the problem of producing extra fused material producing another protrusion may be reduced or eliminated in fused layer ‘n+2’ because the shortened scan path compensates for the extra fused material. In other words, the appearance of extra fused material is no longer unexpected, as it was in fused layer ‘n+1’, but has now become expected and compensated for. In this way, for example, controller may modify the operation of the 3D printer to mitigate the variation of build piece geometry in the previous layer ‘n+1’ and prevent a variation of geometry in the current layer ‘n+2’.

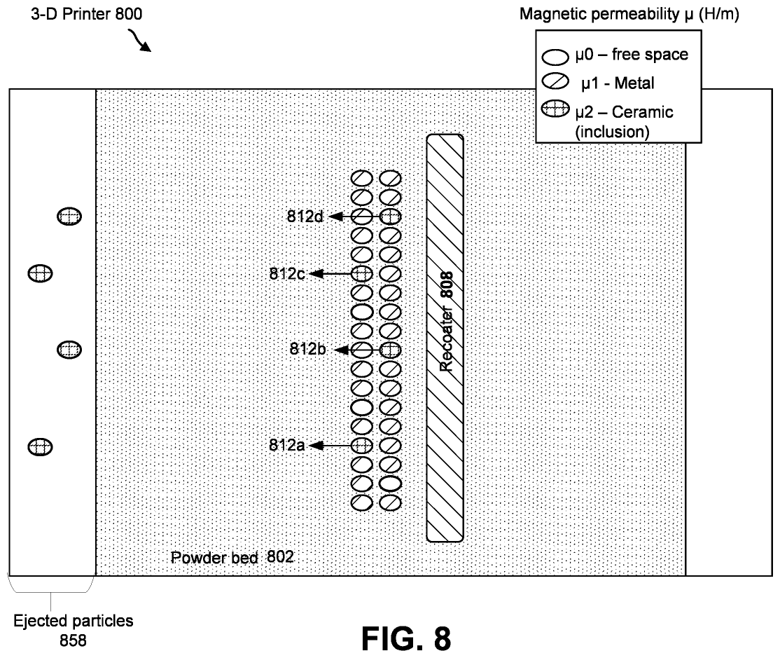

FIG. 8 is a top view of a powder bed 802 and recoater 808 of a 3D printer 800 illustrating the use of magnetic properties of eddy currents to help remove defects. In the case that the printed material is magnetic or paramagnetic, eddy current settings can be adjusted such that a magnetic force is introduced to the powder bed 802, thereby placing the powder bed 802 into an excited mode. In some embodiments, the recoater leveler may be used to induce a magnetic field.

Due to the difference in magnetic properties and the reactions of the ceramic inclusion and metal, the inclusions can be identified based on their permeability and then expelled, using magnetic fields, from the powder bed. Once the inclusions are removed, the magnetic field can be adjusted to increase and excite the metal particles even more, filling the void left by the inclusion as well as any empty space.

The exemplary embodiment of FIG. 8 shows different particles in the powder bed 802 that have different magnetic permeabilities A first area having a first type of marks corresponds to a magnetic permeability of μ0, which represents a metal in the powder bed. A second particle type corresponds to the metallic print material used in the different layers of the powder bed 802, which has a permeability of μ1 and corresponds to the print material in use. A third particle type has a magnetic permeability of μ2 and corresponds to a ceramic, or in some embodiments, an intermetallic material that is an inclusion.

As noted above, the eddy current settings can be configured to identify defects in the powder bed that may cause a reaction shown by arrows 812a-d to selectively cause the different particles (potential inclusions) or spaces with different permeabilities μ0 (a free space indicating avoid) μ1 (metal), μ2 (ceramic) to be identified distinctly from the powder bed 802. These potential inclusions or voids may be ejected using various techniques in or near real time, or after the print, as shown by arrows 812a-d for the potential ceramic inclusions. The ejected particles are shown as particles 858. Accordingly, eddy current sensors can be used for both magnetic and paramagnetic materials to selectively identify defects in the powder bed and to fill void regions with print material as needed.

In some embodiments, other tools, including robotic arm 185 (FIG. 1) or a 3D printed conduit may be used to help complete the removal of the inclusions out of the powder bed 802, in such embodiments where further assistance is necessary. In various additional embodiments, different parameters may be locally modified to re-melt or breakdown the inclusion or spatter. In yet additional embodiments, chemical agents such as reducing acids can also be used to locally dose the spatter to dissolve the spatter after the image sensors identify the spatter's landing location.

In various embodiments, additional powder can be laid down or coated, whether as a layer or selectively in different locations of the powder bed 702, after which an additional laser exposure may be used to re-melt the defective areas. Using this technique, build pieces can be strengthened by removing unmelted powder that may be identified by the sensor system. In still additional embodiments, the 3D printer's recoating action can also be used to remove spatter of a certain size (such as, for example, a size larger than 60% of the layer thickness), mechanically from the top layer.

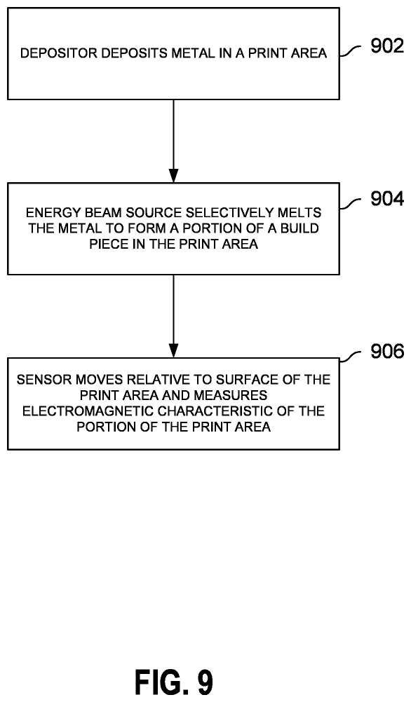

FIG. 9 is an exemplary flow diagram of method of using sensors, such as eddy current sensors, to perform quality assurance and other self-corrective techniques during 3D printing. Referring initially to 902, a depositor on a 3-D printer (which can be a recoater or another depositor for non-PBF techniques) deposits metal in a print area for use in 3-D printing the build piece. In some embodiments, the deposition of metal may be a coating of one of many layers of powder. A number of other embodiments may apply to different types of printers, including those that employ feedstock, for example.

At 904, the energy beam source selectively melts the deposited metal to form a portion of a build piece in the print area. In various embodiments of FIG. 9, the 3-D printer includes at least one eddy current sensor for taking measurements of impedance values and other electromagnetic characteristics in some cases. In some embodiments, optional optical and non-optical sensors may also be employed to complement the data taken by the eddy current sensor.

At 906, the sensor moves relative to the surface of the print area and in so doing, it measures an electromagnetic characteristic of a portion of the print area, e.g., measures an electromagnetic characteristic of the build piece and/or the powder material (in embodiments using powder material). The sensing process may be automated such that the sensor is scheduled to periodically take measurements. In various embodiments, the number of measurements may increase or decrease on the fly, e.g., depending on the complexity of the build or the need for accuracy (e.g., the tolerance) at that stage of the build. This information may be provided by the controller after extracting the 3-D CAD model and slicing the model into 3-D print instructions, for example. In addition, the 3-D printer may in various embodiments be configured to suspend its recoating and/or scanning activities in order to perform various corrective measures.

In various embodiments, for example, the sensor may detect information that may be used to determine defects or potential defects in a part while the part is being printed. For example, detected defects (which may result from spatter or other causes such as sub-optimal printer parameters, variations in powder layer depth, etc.) can include unintended voids, un-fused or partially-fused print material, unsintered powder, cracks, inclusions, contaminants, etc., in the portion of the part or build piece being constructed, and others. The 3D printer may use this data together with existing print specifications for the part (e.g., the CAD model, manufacturer's specifications, etc.) to evaluate whether identified defects or other artifacts require fixing or removal, including when any such actions should be initiated, if at all.

In various embodiments, the sensor may detect information about the powder, e.g., the powder density, quality of powder spread, etc. in powder-based 3D printing. Detecting powder density may include, for example, detecting hollow powder particles by using a sensor frequency matched to the powder size range. In various embodiments, powder layer thickness over the part may be measured, e.g., in embodiments with dual sensors mounted on a bi-directional recoater (in which powder layer thickness may be measured during the recoating itself) or in embodiments with a single sensor mounted on a recoater (in which powder layer thickness may be measured when the recoater returns to a starting position after the recoating).

In various embodiments, the sensor may detect information about the shape of the part being printed. For example, the sensor may detect the edge of the part during printing. The edge of the part corresponds with the part's geometry (i.e., the part's dimensions). In various embodiments, the sensor may detect information below the surface (e.g., below the top layer). For example, the sensor may detect the edge of a printed part from the top surface all the way down for multiple layers. In this way, for example, the sensor can detect and account for dimensional changes in previous layers caused by energy beam penetration below the top layer. This sensor information can provide a more accurate representation of the geometry of the part as it is being printed versus being able to detect the edge of the top layer alone. The information from multiple sensor scans can be combined to obtain a complete dimensional representation of finished part as soon as the printing is completed, thus eliminating the need to dimensionally scan the part during a post-processing step. In various embodiments, this dimensional representation may be used during automated assembly of the part with other parts to enhance the overall dimensional accuracy of the assembly.

The 3D printer may include a controller, such as controller 129, that may use the sensed information to modify the operation of the 3D printer to, e.g., mitigate defects (such as, e.g., physically remove the defect, such as drilling or scraping out an inclusion, adjust printer parameters to correct the defect, such as increasing laser power locally applied to an area in which a void was detected in the current layer or a previous layer, e.g., to re-fuse the area of the defect), flag the defect (e.g., to inform a post-processing treatment such as hot isostatic pressing (HIP), drilling out the defect and filling in the hole afterwards, etc.), or the system may simply end the print job (thus saving time and energy), or take other corrective measures.

In the case of detected errors in powder characteristics, for example, the controller may modify an operation of the 3D printer by, e.g., removing a contaminant in the powder, removing at least some of the metal powder, pausing the print job and replacing the current batch of powder in the system with a new batch, may deposit additional powder (e.g., perform an additional recoat), may adjust printer parameters to mitigate variations in measured powder layer thickness, may end the print job, etc. For example, if the powder layer thickness over the part is too thin in an area, the controller may modify the operation by adjusting the printer parameter of laser power to decrease the energy delivered by the energy beam in the thinner area.

In the case of detected variations in part geometry, for example, the controller may modify the operation by adjusting printer parameters to correct or mitigate the dimensional error, may end the print job, etc. For example, in the case of incomplete fusing near an edge of a previous layer, the controller may apply more laser energy near the edge of a top layer that is above the incompletely fused previous edge to melt or remelt the previous edge to extend (i.e., grow) the geometry of the part to compensate for the incomplete fusing in the previous layer. Similarly, in the case of an edge in a previous layer that protrudes beyond the nominal dimensions, the controller may lower the laser power applied at the edge of the top layer based on the information that the power applied to the edge in the previous layer was too high and caused the edge to extend beyond nominal dimensions. In this way, for example, the controller may adjust printer parameters for future layers based on information that the parameters used for previous layers caused a variation in geometry, so that the future layers can be printed more accurately.

In various embodiments, the eddy current sensor data may be sent to a database even in the event the data is not used immediately. This may be the case, for example, where a database of ideal values is being prepared and the data is being saved to use for future build pieces. Comparing measured values with preexisting values in a database, with a specified tolerance (918), may significantly increase the real time speeds of the prints. In these embodiments, the sensor may include an eddy current sensor that measures impedance, along with one or more additional sensors.

The previous description is provided to enable any person skilled in the art to practice the various aspects described herein. Various modifications to these exemplary embodiments presented throughout this disclosure will be readily apparent to those skilled in the art. Thus, the claims are not intended to be limited to the exemplary embodiments presented throughout the disclosure, but are to be accorded the fu0ll scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A three-dimensional (3-D) printer, comprising:
a depositor configured to deposit metal in a print area of the 3-D printer;
an energy beam source configured to selectively melt the metal to form a portion of a build piece; and
a sensor configured to move relative to a surface of the print area and to measure an electromagnetic characteristic of the portion of the print area.

2. The 3-D printer of claim 1, further comprising a controller configured to modify an operation of the 3-D printer based on the measured electromagnetic characteristic.

3. The 3-D printer of claim 2, wherein the portion of the print area includes the build piece, and the electromagnetic characteristic is an electromagnetic characteristic of the build piece.

4. The 3-D printer of claim 3, wherein the controller is further configured to detect a defect in the build piece based on the electromagnetic characteristic, and modifying the operation is based on the detection of the defect.

5. The 3-D printer of claim 4, wherein the defect includes at least an inclusion, a void, unfused powder, partially-fused powder, a crack, or a contamination.

6. The 3-D printer of claim 4, wherein modifying the operation of the 3-D printer includes at least physically removing the defect, adjusting printer parameters, flagging the defect or ending the printing of the build piece.

7. The 3-D printer of claim 2, wherein the metal includes a metal powder, the portion of the print area includes a portion of the metal powder, and the electromagnetic characteristic includes an electromagnetic characteristic of the metal powder.

8. The 3-D printer of claim 7, wherein the controller is further configured to detect an anomaly in the portion of the metal powder based on the electromagnetic characteristic, and modifying the operation is based on the detection of the anomaly.

9. The 3-D printer of claim 8, wherein the anomaly includes at least a contamination, a powder density, a quality of powder spread, or a variation in thickness of a powder layer.

10. The 3-D printer of claim 8, wherein modifying the operation of the 3-D printer includes at least removing a contaminant from the metal powder, removing at least some of the metal powder, replacing a current batch of the metal powder in the 3-D printer, re-depositing the metal powder, adjusting printer parameters, or ending printing of the build piece.

11. The 3-D printer of claim 1, further comprising a controller configured to determine a variation of a geometry of the build piece based on the electromagnetic characteristic.

13. The 3-D printer of claim 12, wherein determining the variation of the geometry includes detecting an edge of the build piece below a surface of at least the build piece or a powder material.

14. The 3-D printer of claim 12, wherein the controller is further configured to modify an operation of the 3-D printer based on the measured electromagnetic characteristic.

15. The 3-D printer of claim 14, wherein modifying the operation of the 3-D printer includes adjusting printer parameters to mitigate the variation of the geometry.

16. The 3-D printer of claim 15, wherein the variation of the geometry includes an unintended protrusion of the build piece, and adjusting printer parameters includes either increasing or decreasing a laser power of the 3-D printer.

17. The 3-D printer of claim 1, wherein the sensor includes an eddy current sensor.

18. The 3-D printer of claim 1, wherein the sensor is mounted on the depositor.

19. The 3-D printer of claim 1, wherein the electromagnetic characteristic comprises an impedance.

20. A recoater system for a 3-D printer, comprising:
a container for storing print powder;
a leveler;
a powder flow outlet, wherein the leveler is configured to smoothen the print powder from the powder flow outlet to form printable layers in a print bed for 3-D printing a build piece; and
a sensor configured to move relative to the print bed to measure an electromagnetic characteristic of a portion of the build piece.

21. The recoater of claim 20, further comprising an inlet configured to receive the print powder to store in the container.

22. The recoater of claim 20, wherein the sensor includes an eddy current sensor.

23. The recoater of claim 20, wherein the electromagnetic characteristic includes an impedance.

24. The recoater of claim 20, wherein the sensor is configured to identify a defect in the build piece.

25. The recoater of claim 24, wherein the defect comprises a void in the build piece.

26. The recoater of claim 24, wherein the sensor is configured to provide information to a controller of the 3-D printer to remedy the defect during the 3-D printing of the build piece.

27. The recoater of claim 20, wherein the sensor is configured to identify a geometry of the part or portion thereof based on detecting an edge of the build piece.
